(19) United States
(12) Patent Application Publication
(10) Pub. No.: US 2004/0173679 A1
(43) Pub. Date: Sep. 9, 2004

(54) Card reader

(76) Inventors: Hajime Oki, Hyogo (JP); Hiromi Onodera, Nara (JP)

Correspondence Address: McDermott Will & Emery, 600 13th Street NW, Washington, DC, 20005-3096, US

(21) Appl. No.: 10/485,559

(22) PCT Filed: Aug. 5, 2002
(86) PCT No.: PCT/JP02/07953

Related U.S. Application Data
(60) Provisional application No. 60/310,021, filed on Aug. 3, 2001.

(51) Int. Cl. G06K 7/08

(52) U.S. Cl. 235/449

(57) ABSTRACT

A card reader includes readers facing each other, and each one the readers can read information from plural tracks respectively. The card reader further includes a detector for detecting a type of information read by a magnetic head; two magnetic heads; decoders coupled to each one of the tracks respectively; storage sections for storing information decoded. The detector is coupled to every storage section, and controls an output of the information stored in the respective storage sections depending on a type of the information. Information is stored in a magnetic card, and out of the information read by the tracks of the two magnetic heads, only the necessary magnetic card information can be made valid.

### TECHNICAL FIELD

The present invention relates to a card reader for reading the information stored in a magnetic card having a magnetic stripe.

### BACKGROUND ART

A magnetic card (hereinafter referred to simply as “card”) has been widely used as a medium for paying a debit, allowing a credit, and handling a point of sale. The cards are thus accepted at CAT (Credit Authorization Terminal) of various stores and terminals of gasoline pumps in gas stations. The cards are in accordance with JIS (Japan Industrial Standard) and ISO (International Standardization Organization). In general, a variety of cards available in Japanese market are double-sided by JIS II and ISO (on the top and the rear) and those cards have a magnetic stripe on both the faces (hereinafter referred to as JIS II/ISO card). However, in overseas markets, cards are single-sided on rear face by ISO and have a magnetic stripe on the rear face (hereinafter referred to as ISO card). The respective markets have developed terminals adaptable to their own cards and introduced them in the market. Recently, the cards used in Japanese market have been frequently accepted in overseas markets, so that card readers available in the overseas markets are required to accept the cards regardless of single-sided or double-sided card. The card readers also need to be inexpensive and easy to hook up to terminals.

FIG. 11 shows a conventional card reader, having one head, to which a card is manually inserted. A usual gasoline pump is equipped with this conventional card reader. In FIG. 11, a card-reader unit includes insertion-slot cover 16 through which a card is inserted, magnetic head holding means 17 extending to the inside of the cover from the card-reader unit via a partition wall, and magnetic head 1 prepared on the extending section of magnetic head holding means 17. Magnetic head 1 reads the card-data information stored on the magnetic stripe. Circuit 18 is disposed at an upper place of the card-reader unit behind cover 16. Circuit 18 decodes the card data read by the magnetic head, and handles the card data information to be stored.

FIG. 12 shows a conventional card reader including one magnetic head 1 which has plural tracks as well as plural decoders coupled to each one of the tracks respectively. Each one of those decoders comprises decoder IC 5 and decoder IC 6. When an ISO card is inserted into this card reader in a normal posture, i.e. a magnetic stripe of the ISO card is brought into contact with the magnetic head 1, the card data stored in the plural tracks can be read correctly. However, when the card is inserted into the card reader with the magnetic stripe placed on the opposite side to magnetic head 1, the card data stored on the plural tracks cannot be read, so that the card reader cannot handle the data. When a JIS II/ISO card is used in this conventional card reader, the card reader can handle the data on the ISO magnetic stripe while it results in an error in the case of JIS II magnetic stripe.

A conventional card reader shown in FIG. 13 has readers placed opposite to each other and plural magnetic heads each one of which has plural tracks. Each one of those magnetic heads is respectively coupled to decoder IC 5 and decoder IC 6, and the magnetic head can transmit data to the decoder IC corresponding thereto. When an ISO card is inserted to this card reader with the magnetic stripe contacted to the magnetic head, the card data stored on the plural tracks can be handled correctly. However, when a JIS II/ISO card is inserted to this card reader, two types of card data, namely, the data of JIS II and ISO, are mixed in decoder IC 5 and IC 6, so that the card data cannot handled properly even if the card is inserted to the reader in either direction.

A conventional card reader shown in FIG. 14 has readers placed opposite to each other and plural magnetic heads each one of which has plural tracks, and each one of the tracks is respectively coupled to IC decoders 5, 6, 7 or 8. In this structure, each one of the tracks has its own decoder IC, so that the JIS II/ISO card which has a JIS II magnetic stripe on a first face and an ISO magnetic stripe on a second face can be handled properly. In this case, however, plural decoders must be added, and the number of ports of the CPU must be increased, where the CPU is mounted to the interface of the terminal at the gasoline pump. The card data undergo the final processing at this terminal. There has been sometimes a problem that no vacant port is available. In the gas station market, in particular, there is a request in the case of handling the JSI II/ISO cards to neglect the card data of JIS II but handle properly the card data of ISO, without causing any problem to the terminals installed to the gasoline pumps widely used in the market.

The present invention addresses the problems discussed above, and aims to neglect JIS II data and handle ISO data properly when either one of a JIS II/ISO card or an ISO card is inserted into the card reader of the present invention.

### DISCLOSURE OF THE INVENTION

A first card reader of the present invention comprises the following elements:

a magnetic head;

a detector which detects a type of signals read by the magnetic head; and

a storage section for storing the information read by the magnetic head.

The information stored is output depending on a type of the signals detected by the detector.

A second card reader of the present invention comprises the following elements:

two magnetic heads, of which readers face each other, having a plurality of tracks respectively;

a plurality of decoders coupled to each one of the tracks respectively;

storage sections, coupled to each one of the decoders respectively, for storing the information decoded; and

a detector for detecting a type of the information read by one of the magnetic heads and controlling an output of the information stored in the storage section depending on the type of the information.

A third card reader of the present invention comprises the following elements:

two magnetic heads, of which readers face each other, having a plurality of tracks respectively;

a plurality of decoders coupled to each one of the tracks respectively;

storage sections, coupled to each one of the decoders respectively, for storing the information decoded; and

a detector for detecting a type of the information read by one of the magnetic heads.

The detector is coupled to every storage section and controls an output of the information stored in each one of the storage sections depending on a type of the information.

A fourth card reader of the present invention comprises the following elements:

two magnetic heads, of which readers face each other, having a plurality of tracks respectively;

a plurality of decoders coupled to each one of the tracks respectively;

storage sections, coupled to each one of the decoders respectively, for storing the information decoded; and

a detector, coupled to either one of the magnetic heads directly or indirectly, for detecting a type of the information read by the magnetic head coupled to the detector.

The detector controls an output of the information stored in each one of the storage sections depending on a type of the information.

A fifth card reader of the present invention comprises the following elements:

two magnetic heads, of which readers face to each other, having a plurality of tracks respectively;

a plurality of decoders coupled to each one of the tracks respectively;

storage sections, coupled to each one of the decoders respectively, for storing the information decoded; and

detectors, coupled respectively to each one of the magnetic heads directly or indirectly, for detecting a type of the information read by the magnetic head coupled to each one of the detectors.

Each one of the detectors is coupled to the storage section which store the information read by the magnetic heads coupled to the detectors, and controls an output of the information stored depending on the type of the information.

A sixth card reader of the present invention includes a detector which comprises an operational amplifier, a comparator which compares a signal supplied from the operational amplifier with a reference signal and a flip-flop coupled to the comparator.

### BRIEF DESCRIPTION OF THE DRAWINGS

FIG. 1 shows a card in accordance with an exemplary embodiment of the present invention, to be more specific, FIG. 1(a) shows a JIS II card, FIG. 1(b) shows an ISO card, and FIG. 1(c) shows a JIS II/ISO card.

FIG. 2 shows a schematic side view of a card reader in accordance with an exemplary embodiment of the present invention.

FIG. 3 shows a functional block diagram illustrating a structure of the card reader in accordance with an exemplary embodiment of the present invention.

FIG. 4 shows a schematic diagram of an electric circuit included in a detecting circuit of the card reader in accordance with an exemplary embodiment of the present invention.

FIG. 5 shows a timing chart of the electric circuit included in the detecting circuit of the card reader in accordance with the exemplary embodiment of the present invention.

FIG. 6 shows a functional block diagram illustrating a structure of a card reader in accordance with an exemplary embodiment of the present invention.

FIG. 7 shows a placement of magnetic heads and magnetic stripes according to a two-track specification in accordance with an exemplary embodiment of the present invention. To be more specific, FIG. 7(a) illustrates magnetic head 1, and FIG. 7(b) illustrates magnetic head 2.

FIG. 8 shows a functional block diagram illustrating a structure of a card reader in accordance with an exemplary embodiment of the present invention.

FIG. 9 shows a timing chart of a circuit of a card reader in accordance with an exemplary embodiment of the present invention.

FIG. 10 shows a timing chart of a circuit of a card reader in accordance with an exemplary embodiment of the present invention.

FIG. 11 shows a functional block diagram illustrating a structure of a conventional card reader.

FIG. 12 shows a functional block diagram illustrating a structure of a conventional card reader.

FIG. 13 shows a functional block diagram illustrating a structure of a conventional card reader.

FIG. 14 shows a functional block diagram illustrating a structure of a conventional card reader.

### DETAILED DESCRIPTION OF PREFERRED EMBODIMENTS

An exemplary embodiment of the present invention is demonstrated hereinafter with reference to the accompanying drawings.

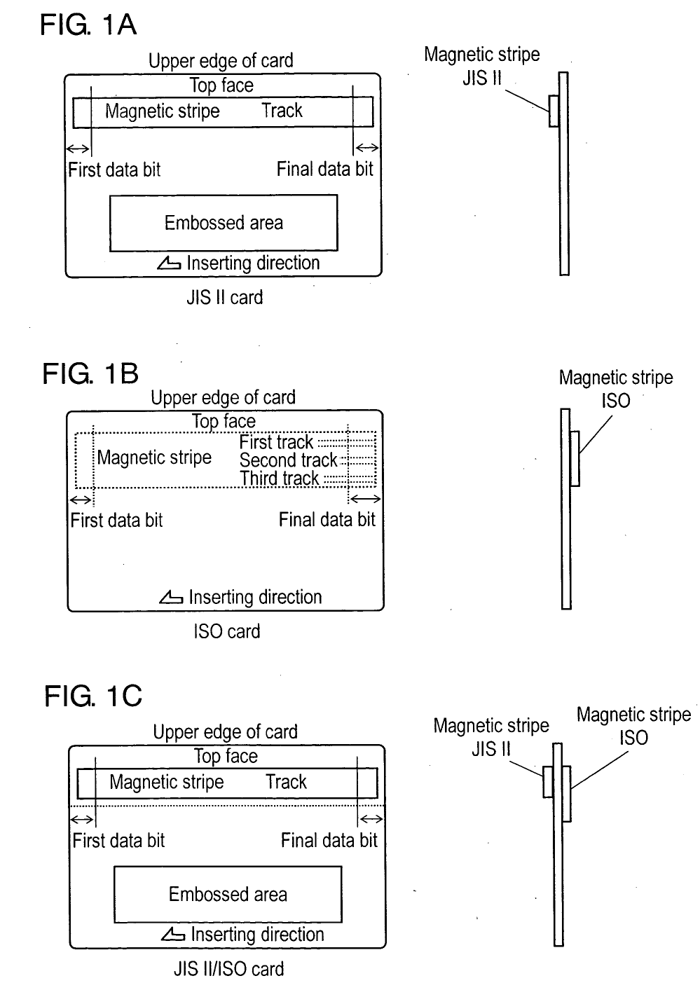

FIG. 1(a) shows the top of a JIS II card, which includes a magnetic -stripe of approx. 6 mm wide. The magnetic stripe has one track therein. FIG. 1(b) shows the top of an ISO card which has a magnetic stripe on the rear. There are two types of ISO card, i.e. one has a magnetic stripe of 12 mm wide and three tracks are included in the stripe, the other one has a magnetic stripe of 6 mm wide and two tracks are included in the stripe. FIG. 1(c) shows the top of a JIS II/ISO card which includes a JIS II magnetic stripe on the top and an ISO magnetic stripe on the rear. The JIS II magnetic stripe is often concealed by graphical design printed on the top, and includes one track (JIS track) of which recording density is 210 BPI. The ISO magnetic stripe, on the other hand, includes three tracks, i.e. ISO track 1 of which recording density is 210 BPI, ISO track 2 of 75 BPI, and ISO track 3 of 210 BPI.

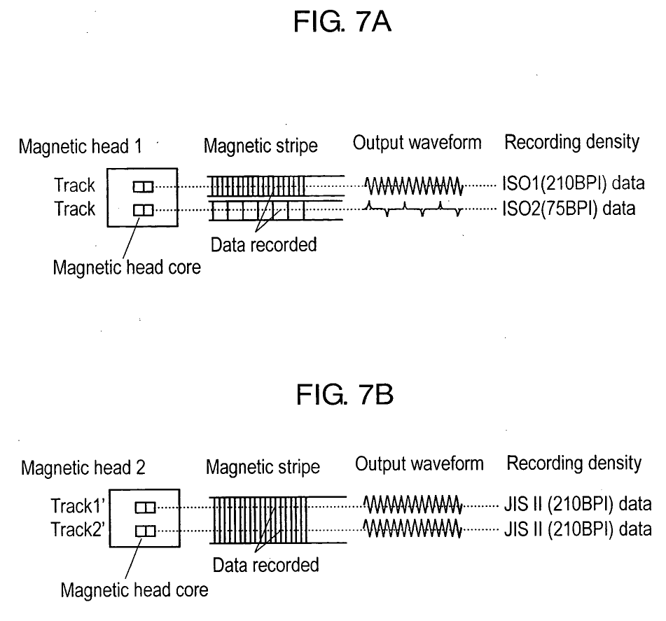

FIG. 7 shows a positional relation between a JIS II track and an ISO track read by two head-cores 101, 102 of the readers in the magnetic head for 2-tracks. In this case, a card is inserted contacting to the magnetic head, which reads the data stored in the track. A first magnetic head outputs the in-phase data of 210 BPI read from the two tracks of JIS II card, while a second magnetic head outputs the data of 210 BPI and 75 BPI in different phases read from the two tracks of ISO card.

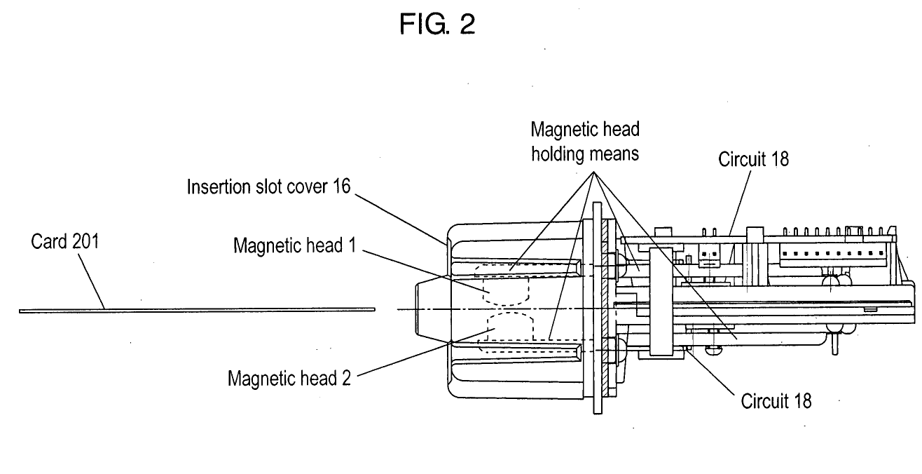

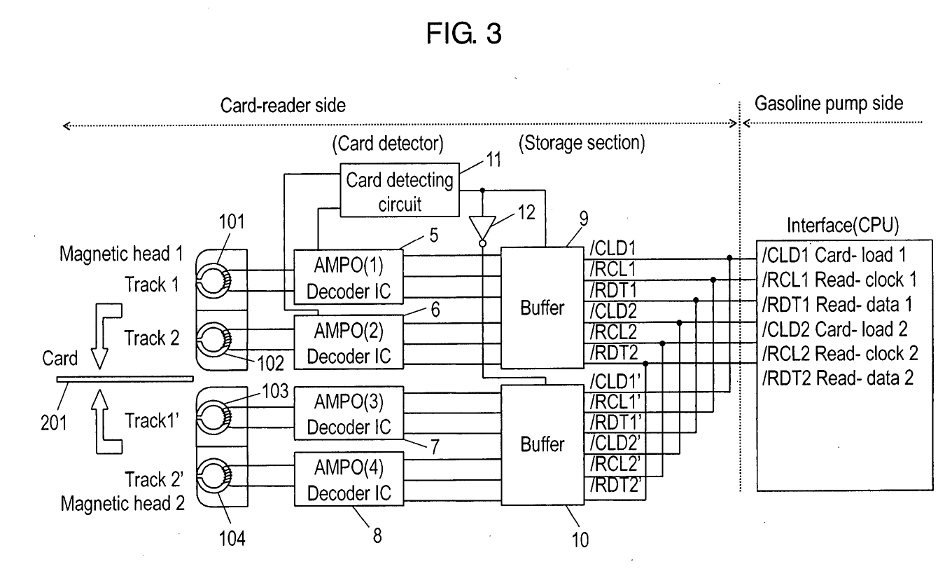

A card reader in accordance with a first exemplary embodiment is demonstrated hereinafter with reference to FIG. 1 through FIG. 5 and FIG. 7. In FIGS. 2 and 3, the card reader includes two magnetic heads 1, 2 facing to each other along the card-guiding slot. When a JIS II/ISO card is inserted into the card reader, magnetic heads 1 and 2 read magnetic-information. Then the magnetic information is supplied to decoder IC5-decoder IC8 which process analog signals that have been read-out and have a micro-amplitude. Decoder IC 5 through IC 8 correspond respectively to each one of the tracks. The decoder IC incorporates the following elements:

a differential amplifier (hereinafter referred to simply as an amplifier) for amplifying micro analog signals supplied from magnetic heads 1 and 2;

a comparator which shapes a waveform of the analog signal; and

a decoder for decoding a serial digital signal which is binary coded to 0 or 1 output through the comparator.

The analog signals supplied from magnetic heads 1 and 2 are separated into the following forms to be handled as data:

a read-clock (/RCL) signal, a read-data (/RDT) signal, and a card-load (/CLD) signal.

First magnetic head 1 (or 2) reads the card data stored on the magnetic stripe on the top of the card, and second magnetic head 2 (or 1) reads the card data stored on the magnetic stripe on the rear face of the card.

First magnetic head 1 includes two cores 101, 102. Second magnetic head 2 includes two cores 103, 104. The analog signal information (card data) read from card 201 by respective magnetic heads 1, 2 is supplied to decoder ICs 5, 6, 7, 8 and controllers disposed in tri-state buffers (hereinafter referred to simply as a buffer). The decoder ICs work for decoding the data, and the controller of the buffer works for controlling an output of the information supplied from the decoder ICs to a terminal such as a gasoline pump. The buffer also works as a storage section. Respective decoder ICs 5, 6, 7, 8 output signal /RDT, the information stored on card 201, signal /RCL and signal /CLD, both signals for processing signal /RDT. Signal /CLD stays ON while the magnetic head reads the data stored on the magnetic stripe. Decoders ICs 5 and 6 are coupled to buffer 9, and ICs 7 and 8 are coupled to buffer 10. The AMPO (amplifier output) signals output from ICs 5 and 6 are supplied to card detecting circuit 11 which works as a detector for detecting a type of the signal read by magnetic head 1. Card detecting circuit 11 detects a type of signals whether the signals of card data read by magnetic head 1 or head 2 are stored on a magnetic stripe on the top or a stripe on the rear face of the card. Then the card data only on the rear face of card 201, i.e. an ISO card data which the user needs, is supplied as a proper data to the gasoline pump via either buffer 9 or buffer 10. For this purpose, card detecting circuit 11 outputs the signals to buffer 9 or through inverter 12 to buffer 10. Buffer 9 or 10 is turned on or off so that either one of the buffers is selected.

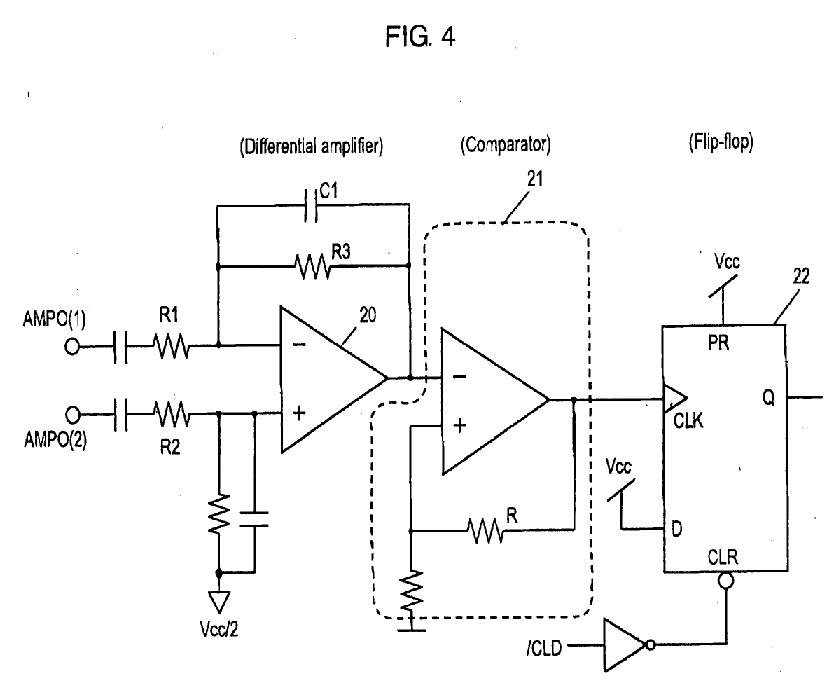

FIG. 4 shows a structure of card detecting circuit 11, which comprises differential amplifier 20, comparator 21, and a main circuit of flip-flop 22. Output signals of AMPO of decoder ICs 5 and 6, namely, AMPO(1) and AMPO(2) are supplied to an inverse input terminal and a non-inverse input terminal of amplifier 20 in circuit 11. An output from amplifier 20 is supplied to flip-flop 22 via comparator 21. Flip-flop 22 outputs a signal that controls ON/OFF of buffers 9 and 10 in the controller.

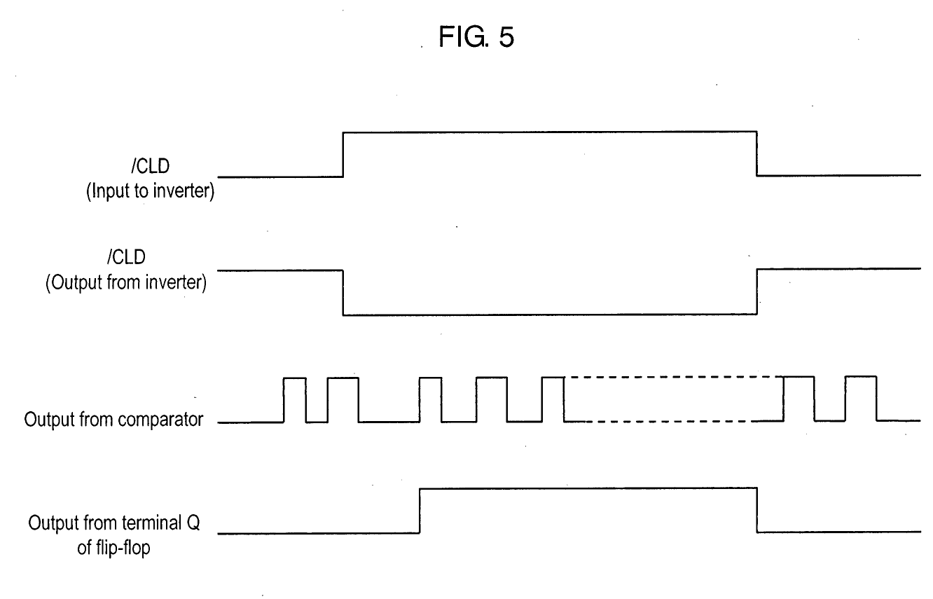

Card 201 is inserted into the card reader so that magnetic head 1 reads an ISO track and head 2 reads a JIS II track. In this case, analog signals having different phases of tracks as shown in FIG. 7(a) are supplied to the input terminal of amplifier 20, and an output from amplifier 20 has analog waveforms mixed in different recording densities of two tracks. Comparator 21 thus outputs a waveform having “H” and “L” at an unfixed cycle as shown in FIG. 5. This output waveform and signal /CLD are supplied to a CLR terminal of flip-flop 22. The signal /CLD is formed of card-load signals /CLD1 and /CLD2, supplied from magnetic heads 1 and 2, undergone NAND gate (not shown). Flip-flop 22 latches at the timing of the signal /CLD, thereby outputting signal Q from terminal Q of flip-flop 22. While the output signal stays at level “H”, signals at level “H” are supplied to buffer 9, and signals at level “L” are supplied to buffer 10. As a result, buffer 9 is turned ON and buffer 10 is turned OFF, so that the card data on the ISO track, i.e. signals /RCL 1, /RDT1, /CLD1, /RCL2, /RDT2, and /CLD2 are sent to the terminal of the gasoline pump. On the other hand, signals of JIS II track data read by head 2 are cut off.

On the contrary, the card is inserted into the card reader so that magnetic head 1 reads the JIS II track and head 2 reads the ISO track. In this case, analog signals in-phase of JIS II tracks as shown in FIG. 7(b) are supplied to the input terminal of amplifier 20, so that amplifier 20 outputs signals at level “L”. Comparator 21 and flip-flop 22 also output signals at level “L”, and supplies signals at level “L” to buffer 9 and signals at level “H” to buffer 10. As a result, buffer 9 is turned OFF, and buffer 10 is turned ON, so that signals of JIS II track data read by head 1 is cut off and the ISO track data read by head 2, i.e. signals /RCL1′, /RDT17, /CLD1′, /RCL2′, /RDT2′, and /CLD2′ are sent to the terminal of the gasoline pump. As such, JIS II track data is cut off, and only ISO track data needed by the user is sent to the terminal.

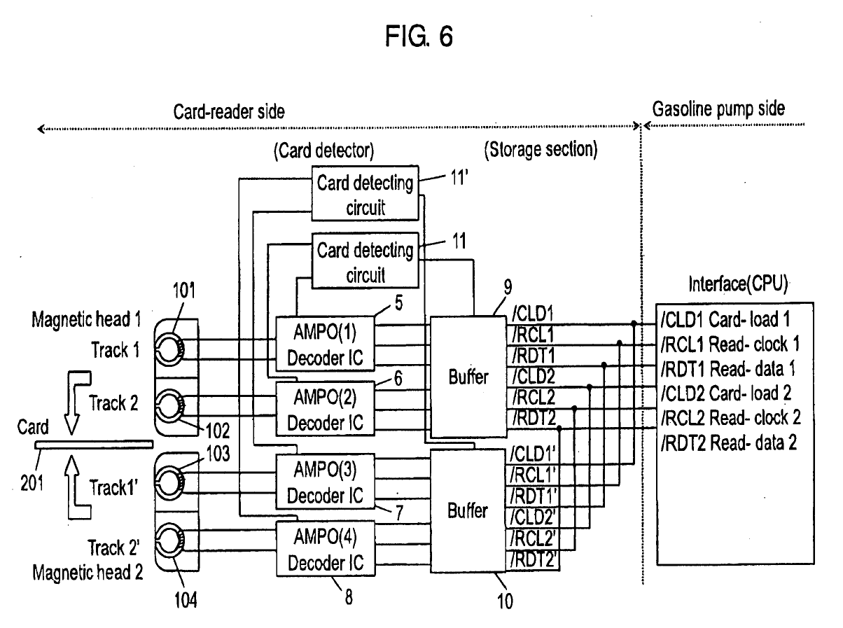

A card reader in accordance with a second exemplary embodiment is demonstrated hereinafter with reference to FIG. 6, which shows decoder ICs 5, 6, 7, and 8 are prepared to each track respectively. This is similar to the circuit shown in FIG. 3 described in the first embodiment discussed above.

The card reader comprises the following elements:

magnetic heads 1 and 2;

decoder ICs 5, 6, 7, and 8 for decoding analog-signal information (card data) read from card 201;

buffers 9 and 10 for storing the information supplied from decoder ICs 5, 6, 7, and 8 and to be sent to a terminal of, e.g. a gasoline pump; and

a controller for controlling the feeding of the information from the buffer to the terminal.

Decoder IC 5 and IC 6 output AIPO (amplifier output) signals to card-detecting circuit 11 which works as a detector for detecting a type of signals read by magnetic head 1. Decoder IC 7 and IC 8 output AMPO signals to card-detecting circuit 11′ which works as a detector for detecting a type of signals read by magnetic head 2. Card-detecting circuit 11′ is formed of the same electric components as those of c Card-detecting circuit 11.

Each magnetic head has a storage section, a detector, and a controller. Each head handles a JIS II/ISO card only to send the ISO track data needed to a user's terminal. This is similar to the operation described in the first embodiment.

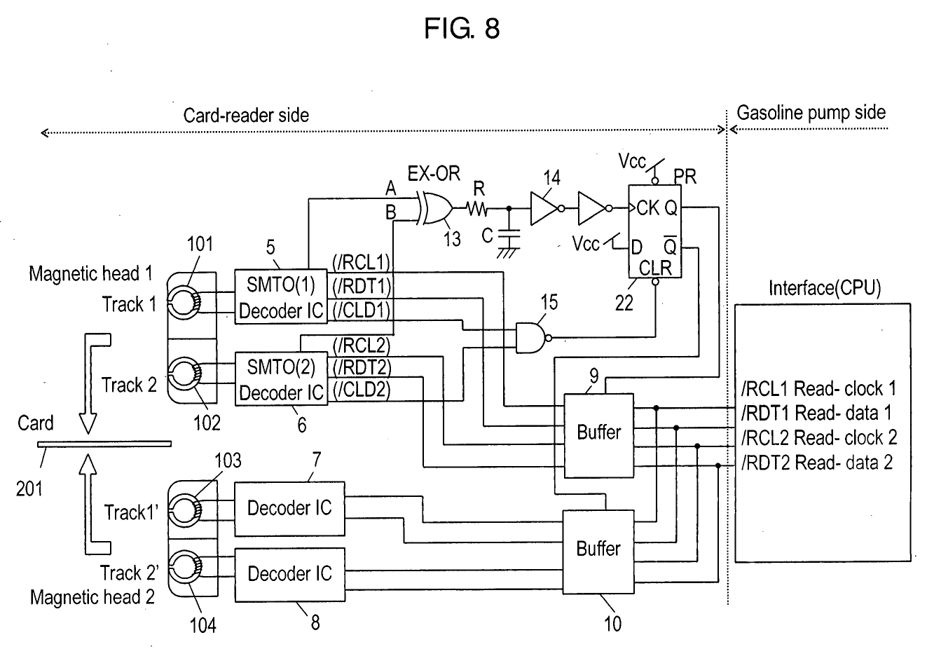

A card reader in accordance with a third exemplary embodiment of the present invention is demonstrated hereinafter with reference to FIG. 8 through FIG. 10. FIG. 8 shows that decoder ICs 5, 6, 7, and 8 are prepared to respective tracks in the same manner as those in the circuit shown in FIG. 3 of the first embodiment. The card reader comprises the following elements:

decoder ICs for decoding analog-signal information (card data) read from card 201;

buffers 9 and 10 for storing the information supplied from decoder ICs and to be sent to a terminal of, e.g. a gasoline pump; and

a controller for controlling the feeding of the information from the buffer to the terminal.

The analog signals of decoder IC 5 and IC 6 are waveform-shaped, then transformed to SMTO (Schmitt Circuit Output) output signals in digital wave forms by Shmitt circuit 14 prepared in the decoder ICs. The SMTO signals is sent to card-detecting circuit 13 which works as a detector for detecting a type of signals read by the magnetic head.

Card-detecting circuit 13 uses the Exclusive-OR circuit, which outputs pulses to flip-flop 22 via Shmitt gate IC 14. Flip-flop 22 outputs a signal for controlling ON/OFF of buffers 9 and 10 of the controller. A CR circuit formed of a resistor and a capacitor is added to the output side of the Exclusive-OR circuit for cutting edge-pulses appearing when flip-flop 22 outputs the signal.

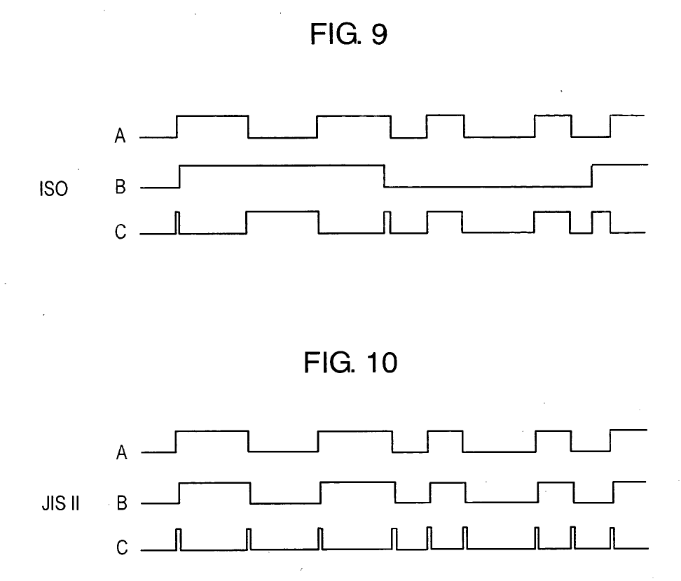

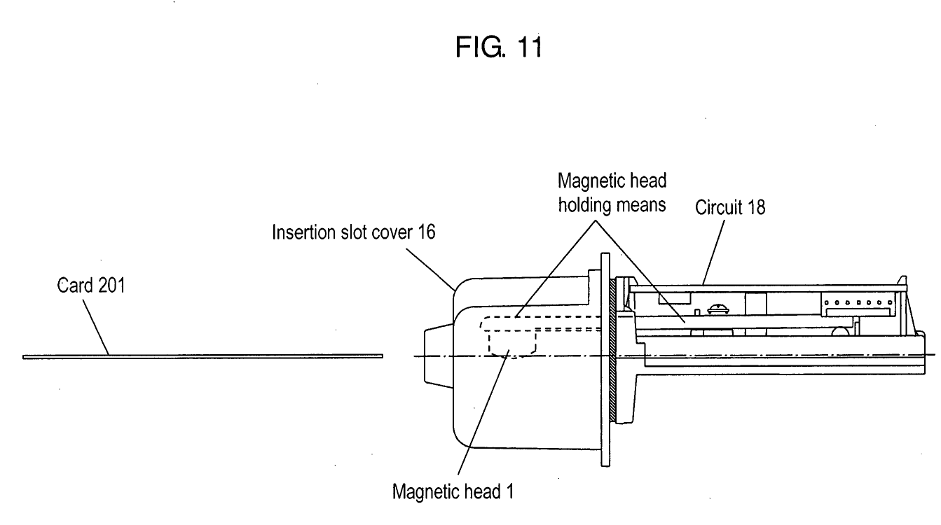

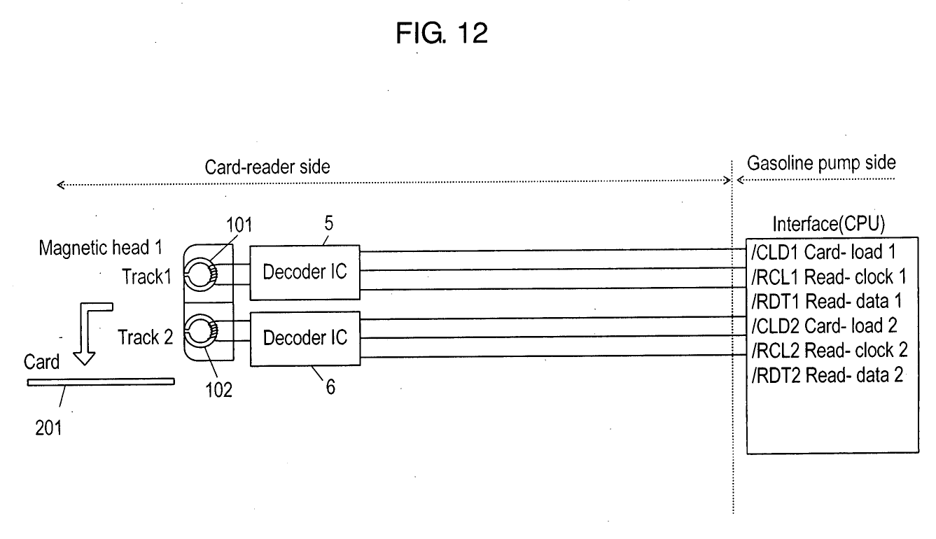

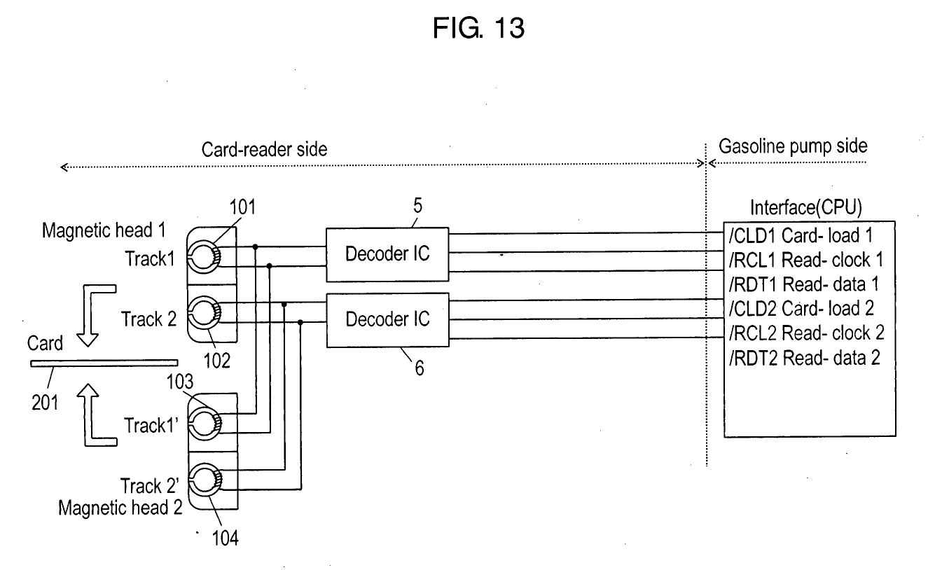

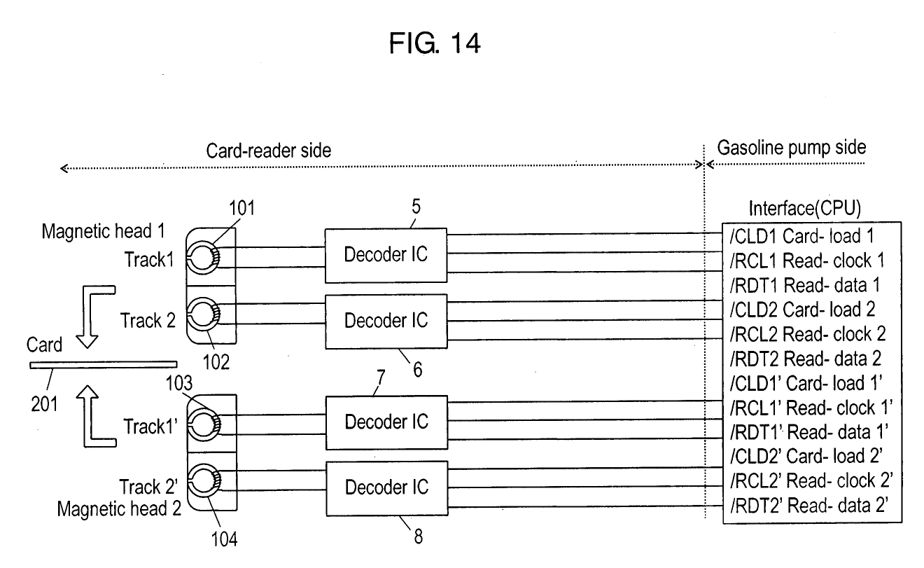

There is a case where card 201 is inserted into the card reader so that magnetic head 1 can read ISO tracks and magnetic head 2 can read JIS II tracks. In this case, if SMTO (Schmitt Circuit Output) signals A and B in different phases of the ISO tracks as shown in FIG. 9 are supplied to an input terminal of the Exclusive-OR circuit in card-detecting circuit 13, digital output waveforms in different recording densities of the two tracks are handled by the Exclusive-OR operation. Flip-flop 22 thus outputs a digital waveform having both of levels “H” and “L” at an unfixed cycle as shown in FIG. 9(c). The card-load signals /CLD1 and /CLD2 read from two tracks by magnetic head 1 undergo NAND gate 15 to become /CLD signal, and is supplied to the CLR terminal of flip-flop 22.

Similar to what is shown in FIG. 5, flip-flop 22 latches at the timing of the digital waveform and signal /CLD, so that flip-flop 22 outputs signals from its terminals Q and Q-bar (inverse output of Q). While the signal tapped off from terminal Q stays level “H”, signals at level “H” are fed into buffer 9 and signals tapped off from terminal Q-bar at level “L” are fed into buffer 10. As a result, buffer 9 is turned ON and buffer 10 is turned OFF, so that the ISO track card data read by magnetic head 1, i.e. signals /RCL1, /RDT1, /CLD1, /RCL2, /RDT2, and /CLD2, are sent to the terminal at the gasoline pump. On the other hand, the JSI II track data read by head 2 are cut off.

Oh the contrary, the card is inserted into the card reader so that magnetic head 1 reads the JIS II track and head 2 reads the ISO track. In this case, signals SMTO(1) and SMTO(2) in phase of JSI II tracks as shown in FIG. 10 are supplied to input terminals A, B of the Exclusive-OR circuit disposed in card-detecting circuit 13. When the signals supplied to terminals A, B are in-phase and do not have a time-lag, the output terminal remains at level “L”; however, if the signals have a time-lag, the output terminal supplies edge-pulses as shown in FIG. 10(c). Those edge pulses can be cut by setting the constant of the CR circuit prepared in the latter stage, so that signals at level “L” are eventually fed into Shmitt gate IC 14 and flip-flop 23. Then signals output from terminal Q through flip-flop 23 remain at level “L”, so that buffer 9 receives signals at level “L”, and signals output from terminal Q-bar (inverse output to Q) are fed into buffer 10 at level “H”. As a result, buffer 9 is turned ON and buffer 10 is turned OFF. Thus the JIS II track data read by head 1 is cut off, and the ISO track data read by head 2, i.e. signals /RCL1, /RDT1, /CLD1, /RCL2, /RDT2, and /CLD2, are sent to the terminal at the gasoline pump. As such, the JIS II track data are cut off while only the ISO track data needed are sent to the user's terminal.

### INDUSTRIAL APPLICABILITY

The first card reader of the present invention comprises the following elements:

a magnetic head;

a detector for detecting a type of signals read by the magnetic head; and

a storage section for storing information read by the magnetic head.

An output of the information stored is controlled depending on a type of the signal detected by the detector, so that only the information stored on a track of a specific magnetic stripe can be made valid before output.

The second card reader of the present invention comprises the following elements:

two magnetic heads, of which readers face each other, having a plurality of tracks respectively;

a plurality of decoders coupled to each one of the tracks respectively;

storage sections, coupled to each one of the decoders respectively, for storing information decoded; and

a detector for detecting a type of information read by one of the magnetic heads.

The detector controls an output of the information stored depending on the type of the information, so that only the information stored on a track of a specific magnetic stripe can be made valid before output.

The third card reader of the present invention comprises the following elements:

two magnetic heads, of which readers face each other, having a plurality of tracks respectively;

a plurality of decoders coupled to each one of the tracks respectively;

storage sections, coupled to each one of the decoders respectively, for storing information decoded; and

a detector for detecting a type of information read by one of the magnetic heads.

The detector is coupled to every storage section, and controls an output of the information stored in the respective storage sections depending on a type of the information, so that only the information stored on a track of a specific magnetic stripe can be made valid before output.

The fourth card reader of the present comprises the following elements:

two magnetic heads, of which readers face each other, having a plurality of tracks respectively;

a plurality of decoders coupled to each one of the tracks respectively;

storage sections, coupled to each one of the decoders respectively, for storing information decoded; and

a detector, coupled to either one of the magnetic heads directly or indirectly, for detecting a type of information read by the magnetic head coupled to the detector.

The detector controls an output of the information stored in the storage section depending on a type of the information, so that only the information stored on a track of a specific magnetic stripe can be made valid before output.

The fifth card reader of the present invention comprises the following elements:

two magnetic heads, of which readers face each other, having a plurality of tracks respectively;

a plurality of decoders coupled to each one of the tracks respectively;

storage sections, coupled to each one of the decoders respectively, for storing information decoded; and

detectors, coupled respectively to each one of the magnetic heads directly or indirectly, for detecting a type of information read by the magnetic head coupled to each one of the detectors.

Each one of the detectors is coupled to the storage section which stores the information read by the magnetic heads coupled to the detectors, and controls an output of the information stored in the storage section depending on a type of the information. As a result, only the information stored on a track of a specific magnetic stripe can be made valid before output.

The sixth card reader of the present invention includes a detector which comprises an operational amplifier, a comparator which compares a signal supplied from the operational amplifier with a reference signal, and a flip-flop coupled to the comparator. This structure allows making only the information stored on a track of a specific magnetic stripe valid before output.

1. A card reader comprising:
a magnetic head;
a detector for detecting a type of signals read by the magnetic head; and
a storage section for storing information read by the magnetic head,
wherein an output of the information stored is controlled depending on a type of the information.

2. A card reader comprising:
two magnetic heads, of which readers face each other, having a plurality of tracks respectively;
a plurality of decoders coupled to each one of the tracks respectively;
storage sections, coupled to each one of the decoders respectively, for storing information decoded; and
a detector for detecting a type of information read by one of the magnetic heads,
wherein the detector controls an output of the information stored depending on a type of the information.

3. A card reader comprising:
two magnetic heads, of which readers face each other, having a plurality of tracks respectively;
a plurality of decoders coupled to each one of the tracks respectively;
storage sections, coupled to each one of the decoders respectively, for storing information decoded; and
a detector for detecting a type of information read by one of the magnetic heads,
wherein, the detector is coupled to every storage section, and controls an output of the information stored in the respective storage sections depending on a type of the information.

4. A card reader comprising:
two magnetic heads, of which readers face each other, having a plurality of tracks respectively;
a plurality of decoders coupled to each one of the tracks respectively;
storage sections, coupled to each one of the decoders respectively, for storing information decoded; and
a detector, coupled to either one of the magnetic heads directly or indirectly, for detecting a type of information read by the magnetic head coupled to the detector,
wherein, the detector controls an output of the information stored in the storage section depending on a type of the information.

5. A card reader comprising:
two magnetic heads, of which readers face each other, having a plurality of tracks respectively;
a plurality of decoders coupled to each one of the tracks respectively;
storage sections, coupled to each one of the decoders respectively, for storing information decoded; and
detectors, coupled respectively to each one of the magnetic heads directly or indirectly, for detecting a type of information read by the magnetic head coupled to each one of the detectors,
wherein, each one of the detectors is coupled to the storage section which stores the information read by the magnetic head coupled to the detector, and controls an output of the information stored in the storage section depending on a type of the information.

6. A card reader of any one of claim 1 through claim 5, wherein the detector includes an operational amplifier, a comparator which compares a signal supplied from the operational amplifier with a reference signal, and a flip-flop coupled to the comparator.
